(19) United States
(12) Patent Application Publication
(10) Pub. No.: US 2021/0036276 A1
(43) Pub. Date: Feb. 4, 2021

(54) MOBILE DEVICE

(71) Applicant: SEIKO EPSON CORPORATION, Tokyo (JP)

(72) Inventors: Ryohei HORITA, Matsumoto (JP); Nobuaki ITO, Shiojiri (JP)

(21) Appl. No.: 16/942,839

(22) Filed: Jul. 30, 2020

(30) Foreign Application Priority Data
Aug. 1, 2019 (JP) 2019-142082

(51) Int. Cl. H01M 2/10; H01M 10/42; H01M 10/0562

(52) U.S. Cl. CPC H01M 2/1066; H01M 2220/30; H01M 10/0562; H01M 10/425

(57) ABSTRACT

A mobile device configured to be driven based on electric power includes a holder in which an all-solid battery having a solid electrolyte is held and a coupler configured to be electrically coupled to the all-solid battery held in the holder. The holder includes a first holder in which a first all-solid battery is fixedly held as the all-solid battery and a second holder in which a second all-solid battery differing in shape from the first all-solid battery is fixedly held as the all-solid battery.

The present application is based on, and claims priority from JP Application Serial Number 2019-142082, filed Aug. 1, 2019, the disclosure of which is hereby incorporated by reference herein in its entirety.

### BACKGROUND

### 1. Technical Field

The present disclosure relates to a mobile device.

### 2. Related Art

There has conventionally been proposed a mobile device that is small in size and light in weight, that has portability, and that includes a drive element. In recent years, an all-solid battery having a solid electrolyte has been developed as one of batteries that are used in such mobile devices. For example, JP-A-2016-175374 discloses, as an example of a mobile device, a portable liquid discharge device in which a lithium-ion battery having a liquid electrolyte is mounted as a battery. Further, JP-A-2-223158 discloses an example of an all-solid battery usable in the mobile device described in JP-A-2016-175374 or other devices.

With the use of a solid electrolyte, the all-solid battery described in JP-A-2-223158 is superior in safety to a liquid electrolyte battery such as a conventional lithium-ion battery. This offers high degrees of freedom in the design and manufacture of batteries. As a result, it is expected that all-solid batteries manufactured in various shapes will be commercially available. On the other hand, the mobile device described in JP-A-2016-175374, which fails to disclose whether a plurality of batteries of different shapes can be selectively mounted, has room for improvement from the viewpoint of enhancing the versatility of a mobile device in which an all-solid battery is mounted.

### SUMMARY

According to an aspect of the present disclosure, there is provided a mobile device configured to be driven based on electric power, the mobile device including: a holder in which an all-solid battery having a solid electrolyte is held; and a coupler configured to be electrically coupled to the all-solid battery held in the holder, wherein the holder includes a first holder in which a first all-solid battery is fixedly held as the all-solid battery, and a second holder in which a second all-solid battery differing in shape from the first all-solid battery is fixedly held as the all-solid battery.

In the aspect of the mobile device, the coupler may be electrically coupled to the first all-solid battery when the first all-solid battery is held in the first holder, and the coupler may be electrically coupled to the second all-solid battery when the second all-solid battery is held in the second holder.

In the aspect of the mobile device, the coupler may include a first coupler and a second coupler, the first coupler may be electrically coupled to the first all-solid battery when the first all-solid battery is held in the first holder, and the second coupler may be electrically coupled to the second all-solid battery when the second all-solid battery is held in the second holder.

In the aspect, the mobile device may further include: a drive circuit configured to be driven based on electric power supplied from the all-solid battery; and a control circuit that, when the first all-solid battery is held in the first holder, operates the drive circuit in a first drive state and that, when the second all-solid battery is held in the second holder, operates the drive circuit in a second drive state differing from the first drive state.

In the aspect of the mobile device, the first holder and the second holder may partially overlap each other in the holder.

In the aspect of the mobile device, the first holder and the second holder may not overlap each other in the holder.

In the aspect, the mobile device may further include a notifier that notifies information on the all-solid battery held in the holder.

In the aspect of the mobile device, the first holder and the second holder may be located adjacent to each other along a first direction in the holder, and the coupler may be located at an end of the holder in a second direction crossing the first direction.

In the aspect of the mobile device, a length of the first holder in the second direction may be smaller than a length of the second holder in the second direction.

In the aspect of the mobile device, a length of the first holder in a third direction crossing the first direction and the second direction may be larger than a length of the second holder in the third direction.

In the aspect, the mobile device may further include a third holder in which a third all-solid battery differing in shape from the first all-solid battery and differing in shape from the second all-solid battery is held.

In the aspect of the mobile device, a rated capacity of the first all-solid battery and a rated capacity of the second all-solid battery may be substantially equal to each other.

In the aspect of the mobile device, the first holder and the second holder may be integrally configured in the holder.

### BRIEF DESCRIPTION OF THE DRAWINGS

FIG. 1 is a diagram of a mobile device as seen from a +Y direction.

FIG. 2 is a diagram of the mobile device as seen from the +Y direction when a cover of the mobile device is open.

FIG. 3 is a diagram of the mobile device as seen from a −Y direction.

FIG. 4 is a diagram showing a cross-section structure of the mobile device when the mobile device is cut along line IV-IV shown in FIG. 2.

FIG. 5 is a diagram showing a functional configuration of the mobile device.

FIG. 6 is a diagram showing an X-Y plane of a holder when the holder is seen from a −Z direction.

FIG. 7A is a diagram showing a cross-section structure of the holder when the holder is cut along line VIIA-VIIA shown in FIG. 6.

FIG. 7B is a diagram showing a cross-section structure of the holder when the holder is cut along line VIIB-VIIB shown in FIG. 6.

FIG. 8 is a diagram showing a Y-Z plane of the holder when the holder is seen from a +X direction.

FIG. 9 is a diagram showing the X-Y plane of the holder when the holder is seen from the −Z direction in a case in which a battery of a first shape is fixedly held in the holder.

FIG. 10A is a diagram showing a cross-section structure of the holder when the holder is cut along line XA-XA while holding the battery of the first shape shown in FIG. 9.

FIG. 10B is a diagram showing a cross-section structure of the holder when the holder is cut along line XB-XB while holding the battery of the first shape shown in FIG. 9.

FIG. 11 is a diagram showing the Y-Z plane of the holder when the holder is seen from the +X direction in a case in which the battery of the first shape is fixedly held in the holder.

FIG. 12 is a diagram showing the X-Y plane of the holder when the holder is seen from the −Z direction in a case in which a battery of a second shape differing in shape from the battery of the first shape is fixedly held in the holder.

FIG. 13A is a diagram showing a cross-section structure of the holder when the holder is cut along line XIIIA-XIIIA while holding the battery of the second shape shown in FIG. 12.

FIG. 13B is a diagram showing a cross-section structure of the holder when the holder is cut along line XIIIB-XIIIB while holding the battery of the second shape shown in FIG. 12.

FIG. 14 is a diagram showing the Y-Z plane of the holder when the holder is seen from the +X direction in a case in which the battery of the second shape is fixedly held in the holder.

FIG. 15 is a diagram showing a functional configuration of a mobile device according to a modification.

FIG. 16 is a diagram of a mobile device of a second embodiment as seen from the front.

FIG. 17 is a diagram of the mobile device of the second embodiment as seen from the rear.

FIG. 18 is a diagram showing a cross-section structure of the mobile device of the second embodiment when the mobile device is cut along line XVIII-XVIII in FIG. 16.

FIG. 19 is a diagram showing an X-Y plane of a holder according to a modification when the holder is seen from the −Z direction.

FIG. 20A is a diagram showing a cross-section structure of the holder when the holder is cut along line XXA-XXA shown in FIG. 19.

FIG. 20B is a diagram showing a cross-section structure of the holder when the holder is cut along line XXB-XXB shown in FIG. 19.

FIG. 21 is a diagram showing a Y-Z plane of the holder when the holder is seen from the +X direction.

FIG. 22 is a diagram showing the X-Y plane of the holder according to the modification when the holder is seen from the −Z direction in a case in which a battery of a first shape is fixedly held in the holder.

FIG. 23A is a diagram showing a cross-section structure of the holder of the modification when the holder is cut along line XXIIIA-XXIIIA while holding the battery of the first shape shown in FIG. 22.

FIG. 23B is a diagram showing a cross-section structure of the holder of the modification when the holder is cut along line XXIIIB-XXIIIB while holding the battery of the first shape shown in FIG. 22.

FIG. 24 is a diagram showing the Y-Z plane of the holder according to the modification when the holder is seen from the +X direction in a case in which the battery of the first shape is fixedly held in the holder.

FIG. 25 is a diagram showing the X-Y plane of the holder according to the modification when the holder is seen from the −Z direction in a case in which a battery of a second shape differing in shape from the battery of the first shape is fixedly held in the holder.

FIG. 26A is a diagram showing a cross-section structure of the holder of the modification when the holder is cut along line XXVIA-XXVIA while holding the battery of the second shape shown in FIG. 25.

FIG. 26B is a diagram showing a cross-section structure of the holder of the modification when the holder is cut along line XXVIB-XXVIB while holding the battery of the second shape shown in FIG. 25.

FIG. 27 is a diagram showing the Y-Z plane of the holder according to the modification when the holder is seen from the +X direction in a case in which the battery of the second shape is fixedly held in the holder.

### DESCRIPTION OF EXEMPLARY EMBODIMENTS

In the following, preferred embodiments of the present disclosure are described with reference to the drawings. The drawings that are referred to are for convenience of explanation. It should be noted that the embodiments to be described below are not intended to unduly limit the contents of the present disclosure recited in the claims. Further, not all of the components to be described below are constituent elements that are essential to the present disclosure.

### 1. FIRST EMBODIMENT

A mobile device of a first embodiment is described by taking as an example a mobile-type ink jet printer serving as a liquid discharge device that forms an image on a medium by discharging ink as a liquid and that is configured to be driven on the basis of electric power supplied from a battery. The mobile-type ink jet printer is hereinafter simply referred to as “mobile printer”. Further, usable examples of media on which the mobile printer forms images include various types of sheets of recording paper such as plain paper for use in printing of images and the like, glossy paper for use in printing of photographs and the like, and post cards.

### 1.1 External Appearance of Mobile Printer

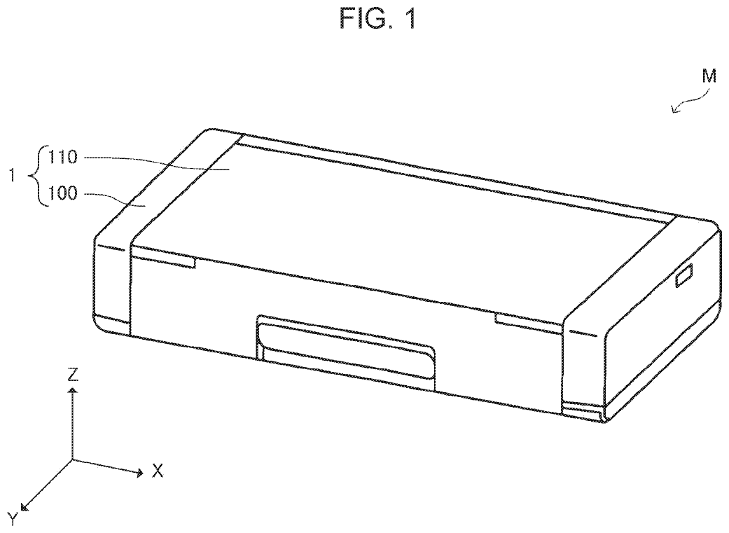

First, an external appearance of a mobile device M is described with reference to FIGS. 1 to 3. It should be noted that the following description uses an X axis, a Y axis, and a Z axis that are orthogonal to one another. Further, a direction toward a starting point of the X axis and a direction toward a side opposite to the starting point may be referred to as “−X direction” and “+X direction”, respectively, and the “−X direction” and the “+X direction” are collectively referred to as “X-axis directions”. Similarly, a direction toward a starting point of the Y axis and a direction toward a side opposite to the starting point may be referred to as “−Y direction” and “+Y direction”, respectively, and the “−Y direction” and the “+Y direction” are collectively referred to as “Y-axis directions”. Similarly, a direction toward a starting point of the Z axis and a direction toward a side opposite to the starting point may be referred to as “−Z direction” and “+Z direction”, respectively, and the “−Z direction” and the “+Z direction” are collectively referred to as “Z-axis directions”. Further, although the following description assumes that the X axis, the Y axis, and the Z axis are orthogonal to one another, units of a mobile printer 1 serving as the mobile device M are not necessarily orthogonal to one another.

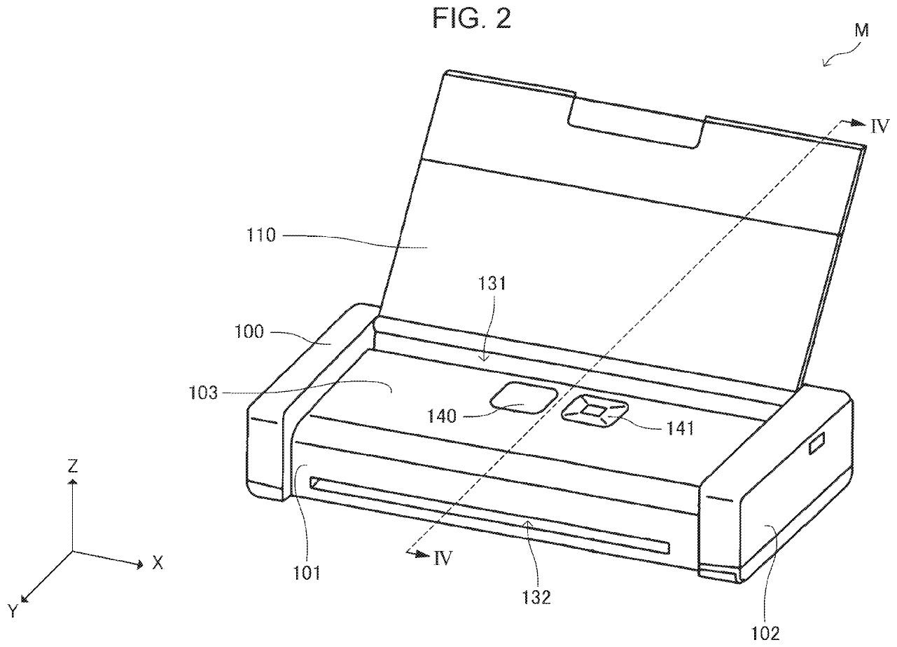

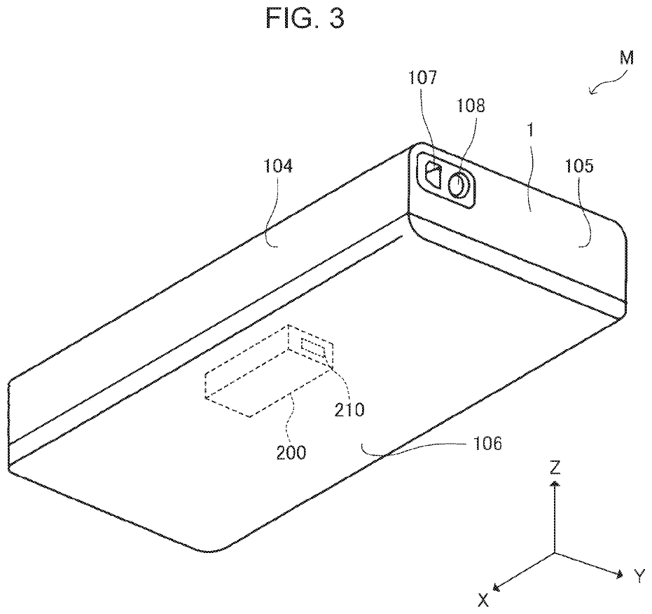

FIG. 1 is a diagram of the mobile device M as seen from the +Y direction. FIG. 2 is a diagram of the mobile device M as seen from the +Y direction when a cover 110 of the mobile device M is open. FIG. 3 is a diagram of the mobile device M as seen from the −Y direction.

As shown in FIG. 1, the mobile printer 1 serving as the mobile device M includes a housing 100 and the cover 110, which is openably and closably provided at the top of the housing 100.

As shown in FIGS. 2 and 3, the housing 100 includes walls 101, 102, 103, 104, 105, and 106. The wall 101 is located in the +Y direction relative to the housing 100. The wall 102 is located in the +X direction relative to the housing 100. The wall 103 is located in the +Z direction relative to the housing 100. The wall 104 is located in the −Y direction relative to the housing 100. The wall 105 is located in the −X direction relative to the housing 100. The wall 106 is located in the −Z direction relative to the housing 100. That is, the wall 101 and the wall 104 are located opposite to each other in a direction parallel to the Y-axis directions. The wall 102 and the wall 105 are located opposite to each other in a direction parallel to the X-axis directions. The wall 103 and the wall 106 are located opposite to each other in a direction parallel to the Z-axis directions. That is, the housing 100 of the mobile printer 1 is substantially in the shape of a cuboid, surrounded by the walls 101 and 106 on six sides, that has a space inside.

Further, the wall 103 of the housing 100 is provided with a display panel 140 and an operation switch 141. The display panel 140 displays information based on the operation and state of the mobile printer 1. The display panel 140 may be configured to include a liquid crystal panel, an electronic paper panel, an organic electroluminescence panel, or other panels. The operation switch 141 accepts an operation carried out by a user. The mobile device M executes a process based on an operation on the operation switch 141. The display panel 140 and the operation switch 141, which are provided in the wall 103, may be a so-called touch panel into which the display panel 140 and the operation switch 141 are integrated.

The wall 103 has provided in the −Y direction relative thereto a feed opening 131 through which a medium is fed into the housing 100 of the mobile printer 1. Further, the wall 101 has provided therein an ejection opening 132 through which a medium supplied into the housing 100 is ejected. A medium supplied into the housing 100 through the feed opening 131 is transported inside the housing 100 and then ejected through the ejection opening 132. Further, while the medium is being transported inside the housing 100, a liquid is discharged onto the medium. This causes an image based on the liquid thus discharged to be formed on a medium to be ejected through the ejection opening 132.

Further, as shown in FIG. 3, the housing 100 houses the after-mentioned holder 200 in which a battery 20 is held and a coupler 210 configured to be electrically coupled to the battery 20 held in the holder 200. Moreover, when the battery 20 has been put into the holder 200, the battery 20 and the coupler 210 are electrically coupled to each other. This causes the mobile printer 1 to be supplied with electric power corresponding to a voltage outputted from the battery 20. That is, the mobile printer 1 operates on the basis of electric power supplied from the battery 20. In the present embodiment, the battery 20 is an example of an all-solid battery having a solid electrolyte.

Further, as shown in FIG. 3, the wall 105 is provided with a DC jack 108 into which a DC (direct-current) plug of an AC (alternating-current) adapter (not illustrated) can be inserted and a USB (universal serial bus) port 107 to which a USB cable can be attached. The mobile printer 1 is communicably connected to an external device such as a personal computer or a digital camera via a USB cable coupled to the USB port 107. This causes the mobile printer 1 to be supplied with image information Img from the external device. Further, the mobile printer 1 is supplied with a voltage Vd via the DC jack 108. That is, the mobile printer 1 can also operate using the voltage Vd, which is inputted via the DC jack 108, as a power supply voltage.

### 1.2 Internal Configuration of Housing of Mobile Printer

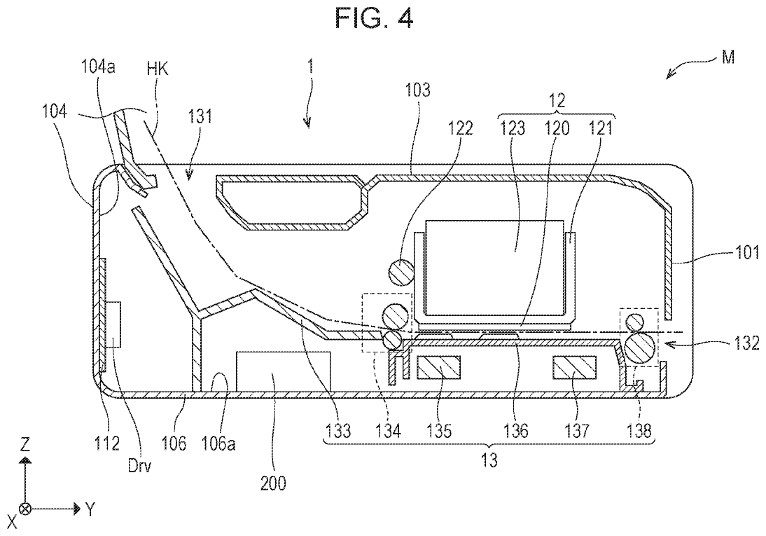

Next, an internal configuration of the housing 100 of the mobile printer 1 is described. FIG. 4 is a diagram showing a cross-section structure of the mobile device M when the mobile device M is cut along line IV-IV shown in FIG. 2.

As shown in FIG. 4, the housing 100 of the mobile printer 1 houses a head unit 12 and a transport unit 13.

The head unit 12 includes a discharge head 120, a carriage 121, and a liquid reservoir 123. The carriage 121 is reciprocatably supported in the −Y direction by a carriage guide shaft 122 extending along the X-axis directions. Moreover, the carriage 121 reciprocates in the X-axis directions while being supported by the carriage guide shaft 122. In the −Z direction relative to the carriage 121, the discharge head 120 is attached. Further, in the +Z direction relative to the carriage 121, the liquid reservoir 123, in which a liquid to be discharged from the discharge head 120 is kept, is mounted. Moreover, the liquid reservoir 123 and the discharge head 120 are coupled to each other by a liquid flow passage (not illustrated). That is, the liquid kept in the liquid reservoir 123 is supplied to the discharge head 120 via the liquid flow passage (not illustrated). Moreover, the discharge head 120 discharges the liquid thus supplied.

The transport unit 13 includes a medium support 133, a pair of transport rollers 134, a drive motor 135, a platen 136, a drive motor 137, and a pair of transport rollers 138. The medium support 133 and the plant 136 form a transport path HK through which a medium fed through the feed opening 131 is transported to the ejection opening 132. A medium fed to the feed opening 131 is transported from the medium support 133 to the platen 136 by driving of the pair of transport rollers 134. The platen 136 is located opposite along the Z-axis directions to the discharge head 120 attached to the carriage 121. Moreover, while the medium is being supported on the platen 136, a liquid is discharged from the discharge head 120, whereby the liquid lands on the medium to form an image. After that, the medium is transported to the ejection opening 132 by driving of the pair of transport rollers 138.

Note here that the pair of transport roller 134 and the pair of transport rollers 138, by which a medium is transported, are controlled by driving of the drive motor 137. Further, the reciprocation of the carriage 121 is controlled by driving of the drive motor 135. That is, the transport of a medium and the movement of the carriage 121 attached to the discharge head 120 are controlled by the drive motors 135 and 137 being controlled. This makes it possible to discharge a predetermined amount of liquid into a desired place on a medium, so that a desired image is formed on the medium.

In the −Y direction relative to the transport path HK, there is provided a circuit board 112 mounted with a plurality of circuits including a drive unit Dry that outputs control signals in accordance with which the head unit 12 and the transport unit 13 operate. The circuit board 112 is attached to an inner surface 104a of the wall 104 of the housing 100. In other words, at least part of the drive unit Dry is in contact with the housing 100. Since the drive unit Dry outputs control signals in accordance with which the head unit 12 and the transport unit 13 operate, the drive unit Dry is highly likely to consume a larger amount of electric power than the head unit 12 and the transport unit 13 and, as a result, may generate more heat than the head unit 12 and the transport unit 13. As shown in FIG. 4, bringing at least part of the drive unit Dry into contact with the housing 100 causes heat generated by the drive unit Dry to be released via the housing 100. This makes it possible to reduce a rise in temperature of the drive unit Dry.

Further, the holder 200 is provided on an inner surface 106a of the wall 106 of the housing 100 in the −Z direction relative to the transport path HK. In a region of contact where the holder 200 is in contact with the wall 106, there may be provided an openable and closable lid (not illustrated) for the battery 20 to be held in the holder 200.

### 1.3 Functional Configuration of Mobile Printer

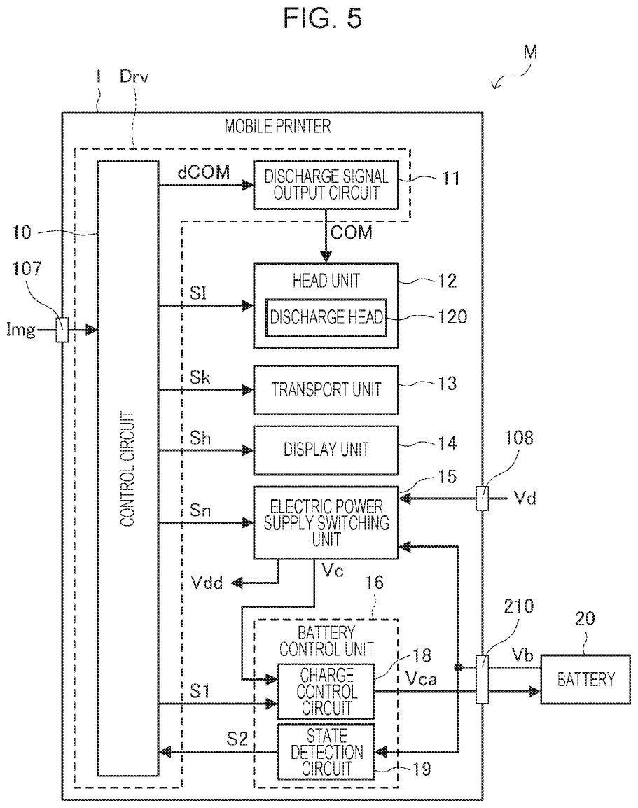

A functional configuration of the mobile printer 1 is described here with reference to FIG. 5. FIG. 5 is a diagram showing a functional configuration of the mobile device M.

The mobile printer 1 includes one or more control circuits 10, a discharge signal output circuit 11, the head unit 12, the transport unit 13, a display unit 14, an electric power supply switching unit 15, and a battery control unit 16.

The control circuit 10 controls operation of the mobile printer 1 by generating various types of control signals on the basis of image information Img inputted from an outside source via the USB port 107 and outputting the control signals. The control circuit 10 is configured to include, for example, a CPU (central processing unit). The control circuit 10 may be configured to include at least one of a DSP (digital signal processor), an ASIC (application-specific integrated circuit), a PLD (programmable logic device), and an FPGA (field-programmable gate array) instead of or in addition to the CPU.

The control circuit 10 generates a waveform-defining signal dCOM, which is a digital signal, for defining the waveform of a discharge signal COM to be outputted from the discharge signal output circuit 11, and outputs the waveform-defining signal dCOM. After having converted a waveform-defining signal dCOM, which is a digital signal, into an analog signal, the discharge signal output circuit 11 generates a discharge signal COM by performing class D amplification of the analog signal thus converted. That is, a waveform-defining signal dCOM is a digital signal that defines the waveform of a discharge signal COM, and the discharge signal output circuit 11 generates a discharge signal COM of a predetermined voltage value by performing class D amplification of a waveform defined by a waveform-defining signal dCOM and outputs the discharge signal COM to the head unit 12. A waveform-defining signal dCOM needs only be a signal that can define the waveform of a discharge signal COM, and may be an analog signal. Further, the discharge signal output circuit 11 needs only be able to amplify to a predetermined voltage value a waveform defined by a waveform-defining signal dCOM, and may be constituted by a class A amplifier circuit, a class B amplifier circuit, a class AB amplifier circuit, or other amplifier circuits.

Further, the control circuit 10 generates a discharge control signal SI for controlling the discharge of a liquid from a liquid discharger (not illustrated) of the discharge head 120 of the head unit 12 and outputs the discharge control signal SI to the head unit 12. The liquid discharger of the discharge head 120 includes a nozzle and a drive element by which a liquid is discharged from the nozzle. The drive element is driven by being supplied with a discharge signal COM. Moreover, an amount of liquid that corresponds to driving of the drive element is discharged from the nozzle. Further, upon receiving a discharge control signal SI, the discharge head 120 controls the supply of a discharge signal COM to the drive element in accordance with the discharge control signal SI. This causes a predetermined amount of liquid to be discharged at a predetermined timing from the nozzle of the liquid discharger of the discharge head 120.

Further, the control circuit 10 generates a transport control signal Sk for controlling the transport unit 13 and outputs the transport control signal Sk to the transport unit 13. The transport unit 13 transports a medium in a predetermined transport direction. Moreover, a desired amount of liquid is discharged into a desired place on a medium by achieving synchronization between a timing at which the transport unit 13 transports a medium in accordance with a transport control signal Sk and a timing at which the discharge head 120 discharges a liquid in accordance with a discharge control signal SI. Accordingly, a desired image is formed on the medium.

Further, the control circuit 10 generates a display control signal Sh for controlling displays of various types of information on the display unit 14 and outputs the display control signal Sh to the display unit 14. The display unit 14 displays various types of information such as information on the operation and state of the mobile device M in accordance with the display control signal Sh. As a result, a user is notified of information including the operation and state of the mobile device M. The display unit 14 may be a so-called touch panel or the like into which the display panel 140 and the operation switch 141 are integrated.

Further, the control circuit 10 generates a power supply selection signal Sn for controlling switching of supply sources from which a power supply voltage is supplied to the mobile printer 1, and outputs the power supply section signal Sn to the electric power supply switching unit 15. The electric power supply switching unit 15 receives a voltage Vb supplied from the battery 20 and a voltage Vd supplied via the DC jack 108 from an AC adapter provided outside the mobile device M. The electric power supply switching unit 15 selects either of the voltages Vb and Vd in accordance with the power supply selection signal Sn and supplies the voltage to each component of the mobile printer 1 as a voltage Vdd serving as a power supply voltage for the mobile printer 1. Further, the electric power supply switch unit 15 generates, on the basis of the voltage Vd, a voltage Vc with to charge the battery 20, and outputs the voltage Vc to the battery control unit 16.

Further, the control circuit 10 generates a control signal S1 for controlling the battery control unit 16 and outputs the control signal S1 to the battery control unit 16. The control circuit 10 receives a state signal S2 from the battery control unit 16. The battery control unit 16 includes a charge control circuit 18 that controls charging of the battery 20 and a state detection circuit 19 that detects a state of the battery 20 and that generates and outputs a state signal S2 representing a detection result.

Specifically, the state detection circuit 19 detects, for example as a state of the battery 20, a voltage value of the voltage Vb supplied from the battery 20. As a result, the state detection circuit 19 detects that the battery 20 is coupled to the coupler 210. Moreover, the state detection circuit 19 generates a state signal S2 representing a state of the battery 20 corresponding to a detection result and outputs the state signal S2 to the control circuit 10. Upon receiving the state signal S2, the control circuit 10 generates a power supply selection signal Sn based on the state signal S2 and outputs the power supply selection signal Sn to the electric power supply switching unit 15. This allows the electric power supply switching unit 15 to select the voltage Vb supplied from the battery 20. Moreover, the electric power supply switching unit 15 selects, in accordance with the power supply selection signal Sn, the voltage Vb supplied from the battery 20 and supplies the voltage Vb as the voltage Vdd to each component of the mobile printer 1, whereby the mobile printer 1 is driven by electric power corresponding to the voltage Vb supplied from the battery 20.

Further, the state detection circuit 19 detects, for example as a state of the battery 20, the voltage value of the voltage Vb supplied from the battery 20 and the temperature of the battery 20, generates a state signal S2 representing a state of the battery 20 corresponding to a detection result, and outputs the state signal S2 to the control circuit 10. The control circuit 10 determines, from the voltage value of the voltage Vb thus detected and the temperature of the battery 20, whether to charge the battery 20, generates a control signal S1 representing a determination result, and outputs the control signal S1 to the charge control circuit 18. In accordance with the control signal S1, the charge control circuit 18 switches whether to output the voltage Vc, which is inputted from the electric power supply switching unit 15, as a voltage Vca with which to charge the battery 20.

Further, in accordance with the state signal S2 outputted from the state detection circuit 19, the control circuit 10 may acquire information on the battery 20 held in the holder 200 and cause the display unit 14 to display the information thus acquired. That is, the display unit 14 is an example of a notifier that notifies information on the battery 20.

In the mobile printer 1, which operates on the basis of electric power supplied from the battery 20, the head unit 12, which is driven in accordance with a discharge signal COM and a discharge control signal SI, is an example of a drive circuit, and the transport unit 13, which is driven in accordance with a transport control signal Sk, and the display unit 14, which is driven in accordance with a display control signal Sh, are other examples of drive circuits. Moreover, the control circuit 10, which outputs control signals to control the head unit 12, the transport unit 13, and the display unit 14, is an example of a control circuit. In FIG. 5, the battery 20 appears to be provided outside the mobile printer 1; however, in actuality, the battery 20 is detachably provided in the holder 200 inside the mobile printer 1.

### 1.4 Configuration of Holder

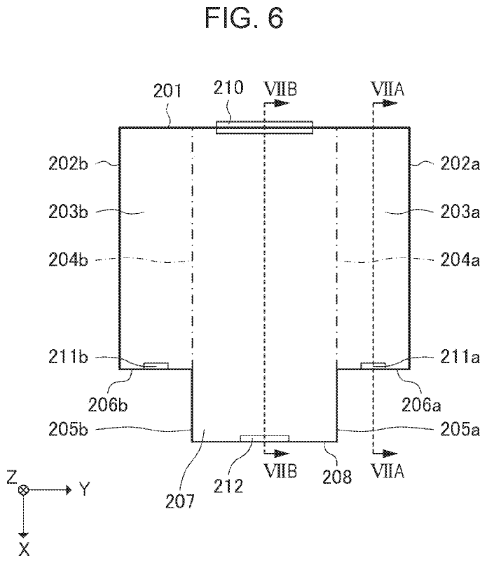

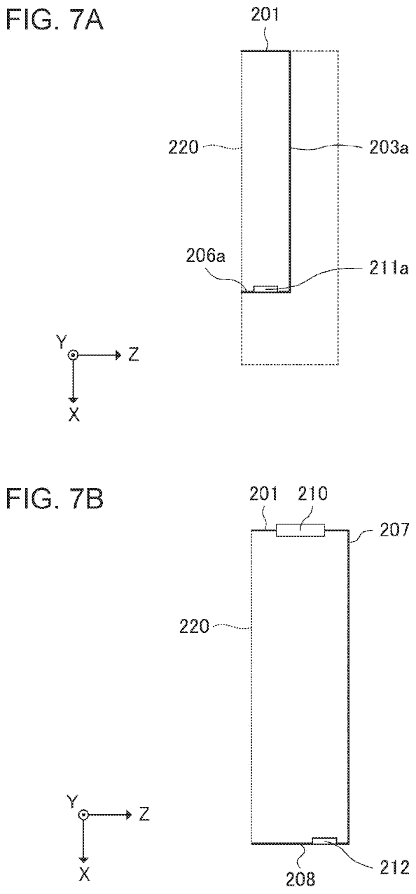

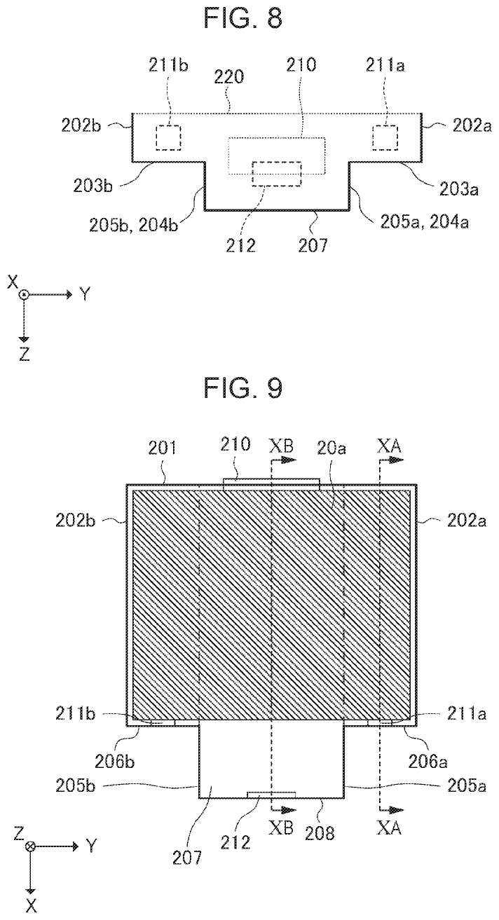

Next, the shape and configuration of the holder 200, in which a battery 20 is held, are described. FIG. 6 is a diagram showing an X-Y plane of the holder 200 when the holder 200 is seen from the −Z direction. FIG. 7A is a diagram showing a cross-section structure of the holder 200 when the holder 200 is cut along line VIIA-VIIA shown in FIG. 6. FIG. 7B is a diagram showing a cross-section structure of the holder 200 when the holder 200 is cut along line VIIB-VIIB shown in FIG. 6. FIG. 8 is a diagram showing a Y-Z plane of the holder 200 when the holder 200 is seen from the +X direction. The holder 200 has the same shape regardless of whether it is seen from the +Y direction or it is seen from the −Y direction. Therefore, a diagram showing the holder 200 when the holder 200 is seen from the −Y direction is omitted. In the present embodiment, a battery 20a and a battery 20b are inserted into the holder 200 from the −Z direction.

As shown in FIGS. 6 to 8, the holder 200 has walls 201, 202a, 202b, 203a, 203b, 204a, 204b, 205a, 205b, 206a, 206b, 207, and 208, which are plate-like members. Further, although not illustrated in FIGS. 6 to 8, a sealing member with which the holder 200 is sealed after the battery 20a or the battery 20b has been put into the holder 200 may be provided at the after-mentioned opening surface 220 located in the −Z direction relative to the holder 200.

The wall 207 extends in the X-Y plane and is located in the +Z direction relative to the holder 200.

At an end of the wall 207 in the +Y direction, the wall 204a, which extends in the −Z direction relative to the wall 207 in an X-Z plane, is located. Further, at an end of the wall 207 in the −Y direction, the wall 204b, which extends in the −Z direction relative to the wall 207 in the X-Z plane, is located. That is, the wall 204a and the wall 204b are located opposite to each other along the Y-axis directions.

At an end of the wall 204a in the −Z direction, the wall 203a, which extends in the +Y direction relative to the wall 204a in the X-Y plane, is located. Further, at an end of the wall 204b in the −Z direction, the wall 203b, which extends in the −Y direction relative to the wall 204b in the X-Y plane, is located. Note here that the wall 203a and the wall 203b are located in the same X-Y plane along the Z-axis directions.

At an end of the wall 203a in the +Y direction, the wall 202a, which extends in the −Z direction relative to the wall 203a in the X-Z plane, is located. Further, at an end of the wall 203b in the −Y direction, the wall 202b, which extends in the −Z direction relative to the wall 203b in the X-Z plane, is located. That is, the wall 202a and the wall 202b are located opposite to each other along the Y-axis directions.

Note here that it is preferable that 0.5×P<Q<P, wherein P is the length of each of the walls 202a and 202b along the Z-axis directions and Q is the length of the battery 20a along the Z-axis directions. As will be mentioned later, the walls 202a and 202b correspond to side walls when the battery 20a has been put into the mobile printer 1. Therefore, when P<Q, the battery 20a cannot be put into the holder 200. Further, when 0.5×P>Q, there is a great gap between an end of the battery 20a in the −Z direction and the sealing member, even if the battery 20a has been put into the holder 200. This may cause a displacement of the battery 20a in the holder 200.

Further, at an end of the wall 207 in the −X direction, the wall 201, which extends in the −Z direction relative to the wall 207 in the Y-Z plane, is located. To this wall 201, an end of each of the aforementioned walls 202a, 202b, 203a, 203b, 204a, and 204b in the −X direction is coupled.

Note here that it is preferable that 0.5×R<S<R, wherein R is the length of the wall 201 along the Z-axis directions and S is the length of the battery 20b along the Z-axis directions. As will be mentioned later, the wall 201 corresponds to a side wall when the battery 20b has been put into the mobile printer 1. Therefore, when R<S, the battery 20b cannot be put into the holder 200. Further, when 0.5×R>S, there is a great gap between an end of the battery 20b in the −Z direction and the sealing member, even if the battery 20b has been put into the holder 200. This may cause a displacement of the battery 20b.

At an end of the wall 203a in the +X direction, the wall 206a, which extends in the −Z direction relative to the wall 203a in the Y-Z plane, is located. An end of the wall 206a in the +Y direction is coupled to an end of the wall 202a in the +X direction. Further, at an end of the wall 203b in the +X direction, the wall 206b, which extends in the −Z direction relative to the wall 203b in the Y-Z plane, is located. An end of the wall 206b in the −Y direction is coupled to an end of the wall 202b in the +X direction. Note here that the wall 206a and the wall 206b are located in the same Y-Z plane along the X-axis directions.

Further, the wall 205a, which extends in the −Z direction relative to the wall 207 in the X-Y plane, is located in the +X direction relative to a region at the end of the wall 207 in the +Y direction where the wall 207 and the wall 204a are coupled to each other. Further, the wall 205b, which extends in the −Z direction relative to the wall 207 in the X-Z plane, is located in the +X direction relative to a region at the end of the wall 207 in the −Y direction where the wall 207 and the wall 204b are coupled to each other. Note here that the wall 205a and the wall 204a are located adjacent to each other in the X-Z plane and the wall 205b and the wall 204b are located adjacent to each other in the X-Z plane. That is, the wall 205a and the wall 204a are a continuous plate-like member extending in the same X-Z plane along the Y-axis directions, and the wall 205b and the wall 204b are a continuous plate-like member extending in the same X-Z plane along the Y-axis directions.

At an end of the wall 207 in the +X direction, the wall 208, which extends in the −Z direction relative to the wall 207 in the Y-Z plane, is located. To this wall 208, an end of each of the aforementioned walls 205a and 205b in the +X direction is coupled.

Further, the holder 200 has an opening surface 220 located at a position in the holder 200 opposite to the wall 207 in the −Z direction. Moreover, the battery 20 is held in the holder 200 by being inserted from the −Z direction relative to the opening surface 220.

Having such a shape, the holder 200 can hold batteries 20 of different shapes in one space constituted by the walls 201, 202a, 202b, 203a, 203b, 204a, 204b, 205a, 205b, 206a, 206b, 207, and 208, which are plate-like members, and the opening surface 220.

Further, the holder 200 includes the coupler 210 configured to be electrically coupled to the battery 20 held in the holder 200 and fixtures 211a, 211b, and 212 configured to fix the battery 20 held in the holder 200. The coupler 210 is provided in the wall 201, which is an end of the holder 200 in the −X direction. Further, the fixtures 211a and 211b are provided on the walls 206a and 206b, respectively. Further, the fixture 212 is provided on the wall 208. Moreover, in the holder 200, a battery 20 of a first shape is fixedly held by the coupler 210 and the fixtures 211a and 211b, or a battery 20 of a second shape differing from the first shape is fixedly held by the coupler 210 and the fixture 212. Note here that the fixtures 211a, 211b, and 212 are configured to include, for example, elastic members such as springs. Moreover, once a battery 20 is held in the holder 200, the battery 20 is fixed between stress caused by the elastic member(s) and the coupler 210.

Examples of cases where a battery 20 is held in the holder 200 are described with reference to FIGS. 9 to 14.

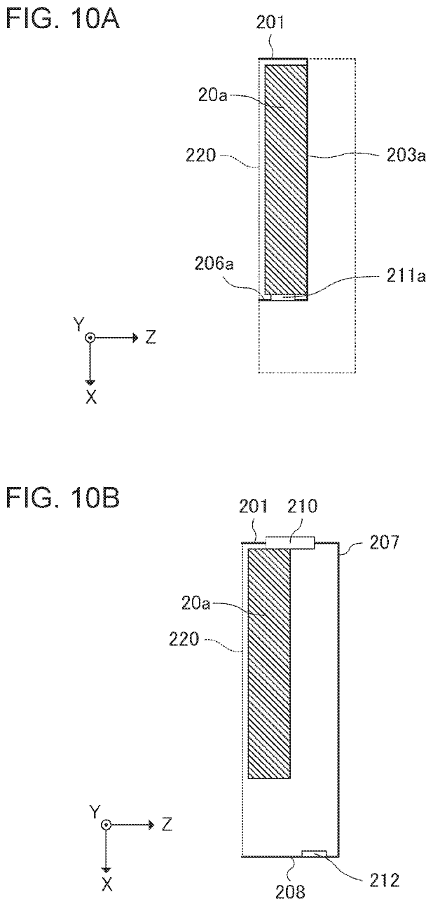

FIG. 9 is a diagram showing the X-Y plane of the holder 200 when the holder 200 is seen from the −Z direction in a case in which a battery 20 of a first shape is fixedly held in the holder 200. FIG. 10A is a diagram showing a cross-section structure of the holder 200 when the holder 200 is cut along line XA-XA while holding the battery 20 of the first shape shown in FIG. 9. FIG. 10B is a diagram showing a cross-section structure of the holder 200 when the holder 200 is cut along line XB-XB while holding the battery 20 of the first shape shown in FIG. 9. FIG. 11 is a diagram showing the Y-Z plane of the holder 200 when the holder 200 is seen from the +X direction in a case in which the battery 20 of the first shape is fixedly held in the holder 200. It should be noted that the battery 20 of the first shape is hereinafter sometimes simply referred to as “battery 20a”.

As shown in FIGS. 9 to 11, the battery 20a put into the holder 200 is held in the holder 200 by being retained by the walls 203a and 203b and fixed by the fixtures 211a and 211b and the coupler 210 in a substantially cuboidal holding region configured to include the walls 201, 202a, 202b, 206a, 206b, 203a, and 203b. In other words, the battery 20a is fixedly held in the substantially cuboidal holding region configured to include the walls 201, 202a, 202b, 206a, 206b, 203a, and 203b. In this case, the battery 20a is electrically coupled to the coupler 210. Note here that the substantially cuboidal holding region configured to include the walls 201, 202a, 202b, 206a, 206b, 203a, and 203b is an example of a first holder and the battery 20a held in the substantially cuboidal holding region configured to include the walls 201, 202a, 202b, 206a, 206b, 203a, and 203b is an example of a first all-solid battery.

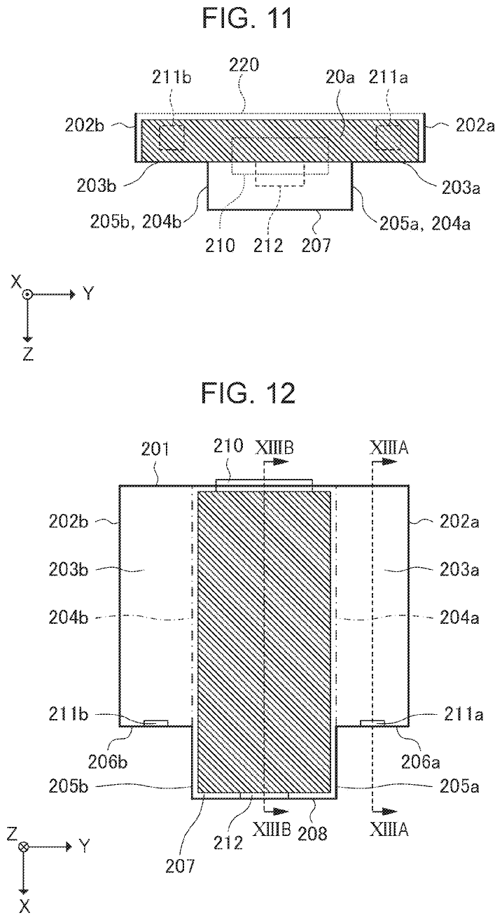

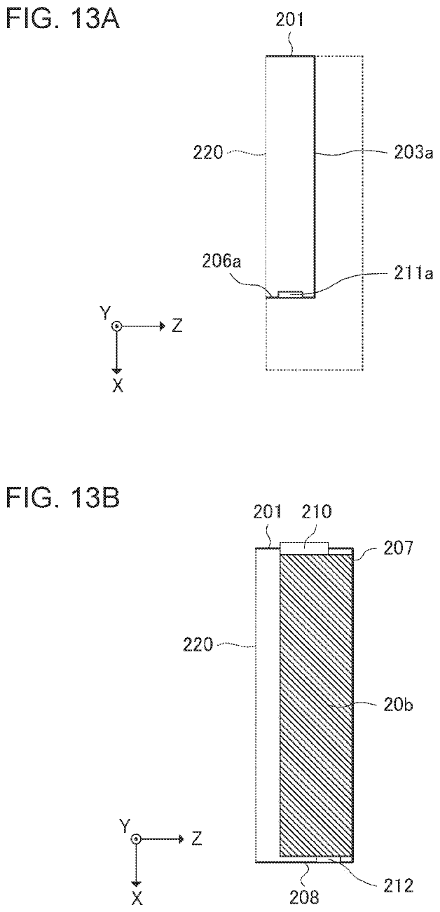

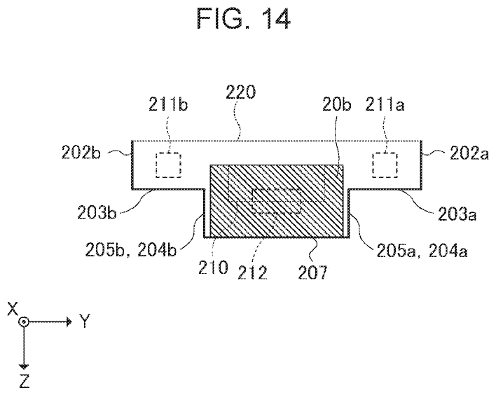

FIG. 12 is a diagram showing the X-Y plane of the holder 200 when the holder 200 is seen from the −Z direction in a case in which a battery 20 of a second shape differing in shape from the battery 20a is fixedly held in the holder 200. FIG. 13A is a diagram showing a cross-section structure of the holder 200 when the holder 200 is cut along line XIIIA-XIIIA while holding the battery 20 of the second shape shown in FIG. 12. FIG. 13B is a diagram showing a cross-section structure of the holder 200 when the holder 200 is cut along line XIIIB-XIIIB while holding the battery 20 of the second shape shown in FIG. 12. FIG. 14 is a diagram showing the Y-Z plane of the holder 200 when the holder 200 is seen from the +X direction in a case in which the battery 20 of the second shape is fixedly held in the holder 200. It should be noted that the battery 20 of the second shape is hereinafter sometimes simply referred to as “battery 20b”.

As shown in FIGS. 12 to 14, the battery 20b put into the holder 200 is held in the holder 200 by being retained by the wall 207 and fixed by the fixture 212 and the coupler 210 in a substantially cuboidal holding region configured to include the walls 201, 204a, 204b, 205a, 205b, 207, and 208. In other words, the battery 20b is fixedly held in the substantially cuboidal holding region configured to include the walls 201, 204a, 204b, 205a, 205b, 207, and 208. In this case, the battery 20b is electrically coupled to the coupler 210. Note here that the substantially cuboidal holding region configured to include the walls 201, 204a, 204b, 205a, 205b, 207, and 208 is an example of a second holder and the battery 20b held in the substantially cuboidal holding region configured to include the walls 201, 204a, 204b, 205a, 205b, 207, and 208 is an example of a second all-solid battery.

Further, as shown in FIGS. 9 to 14, the substantially cuboidal holding region, configured to include the walls 201, 202a, 202b, 206a, 206b, 203a, and 203b, in which the battery 20a put into the holder 200 is fixedly held and the substantially cuboidal holding region, configured to include the walls 201, 204a, 204b, 205a, 205b, 207, and 208, in which the battery 20b put into the holder 200 is fixedly held are integrally configured in the holder 200 and located adjacent to each other along the Z-axis directions, and the coupler 210, to which the battery 20a and the battery 20b are electrically coupled, is provided in the wall 201, which is an end of the holder 200 in a direction parallel to the X axis that crosses to the Z axis.

Furthermore, the length along the X-axis directions of the substantially cuboidal holding region, configured to include the walls 201, 202a, 202b, 206a, 206b, 203a, and 203b, in which the battery 20a is fixedly held is smaller than the length along the X-axis directions of the substantially cuboidal holding region, configured to include the walls 201, 204a, 204b, 205a, 205b, 207, and 208, in which the battery 20b is fixedly held, and along the Y-axis directions that crosses to both the Z-axis directions and the X-axis directions, the length of the substantially cuboidal holding region, configured to include the walls 201, 202a, 202b, 206a, 206b, 203a, and 203b, in which the battery 20a is fixedly held is larger than the length of the substantially cuboidal holding region, configured to include the walls 201, 204a, 204b, 205a, 205b, 207, and 208, in which the battery 20b is fixedly held.

That is, in the present embodiment, the holder 200 can fixedly hold two types of battery 20 differing in length along the X-axis directions and the Y-axis directions from each other. This makes it possible to selectively use a plurality of batteries of different shapes in a mobile device M and makes it possible to enhance the versatility of a mobile device M in which a battery 20 is mounted.

Further, as shown in FIGS. 9 to 14, the substantially cuboidal holding region, configured to include the walls 201, 202a, 202b, 206a, 206b, 203a, and 203b, in which the battery 20a is fixedly held and the substantially cuboidal holding region, configured to include the walls 201, 204a, 204b, 205a, 205b, 207, and 208, in which the battery 20b is fixedly held partially overlap each other. Since, as shown in FIGS. 9 to 14, the holding region in which the battery 20a is held and the holding region in which the battery 20b is held are provided in the holder 200 so as to overlap each other, it is possible to reduce the size of the holder 200, in which a plurality of batteries 20 of different shapes are fixedly held. This makes it possible to reduce the risk of an increase in size of a mobile device M including a holder 200 configured to hold batteries 20a and 20b of different shapes.

Further, it is preferable that the rated capacity of a battery 20a that is held in the holder 200 and the rated capacity of a battery 20b that is held in the holder 200 be substantially equal to each other. In other words, even in the case of batteries 20 of different shapes, it is preferable that batteries that are held in the holder 200 be substantially equal in rated capacity to each other. This stabilizes the amounts of electric power that are supplied from batteries 20 of different shapes and, as a result, makes it possible to stabilize the operation of the mobile device M. Note here that being substantially equal in rated capacity means that the rated capacity of the battery 20a and the rated capacity of the battery 20b are about equal to each other even with consideration given to variations in the rated capacity of the battery 20a and the rated capacity of the battery 20b, and encompasses an overlap between at least part of a range of rated capacity of the battery 20a including variations and at least part of a range of rated capacity of the battery 20b including variations.

Note here that the Z-axis directions are an example of a first direction, that the X-axis directions are an example of a second direction, and that the Y-axis directions are an example of a third direction.

### 1.5 Working Effects

As described above, in a mobile printer 1 serving as a mobile device M according to the present embodiment, a holder 200 in which a battery 20, constituted by an all-solid battery having a solid electrolyte, that supplies electric power for the mobile printer 1 to operate is held includes a holding region in which a battery 20a serving as the battery 20 is fixedly held and a holding region in which a battery 20b serving as the battery 20 and differing in shape from the battery 20a is fixedly held, and the holding region in which the battery 20a serving as the battery 20 is fixedly held and the holding region in which the battery 20b serving as the battery 20 is fixedly held are integrally configured. This makes it possible to put batteries 20 of different shapes into the holder 200. This makes it possible to selectively use batteries 20 of different shapes and makes it possible to enhance the versatility of a mobile device M in which a battery 20, which is an all-solid battery, is mounted.

### 1.6 Modification of Holder

Although the mobile device M according to the first embodiment has been described assuming that a battery 20a or a battery 20b is fixedly held in the holder 200 by being inserted into the holder 200 from the −Z direction, a battery 20a or a battery 20b may be fixedly held in the holder 200 by being inserted into the holder 200 from the +X direction.

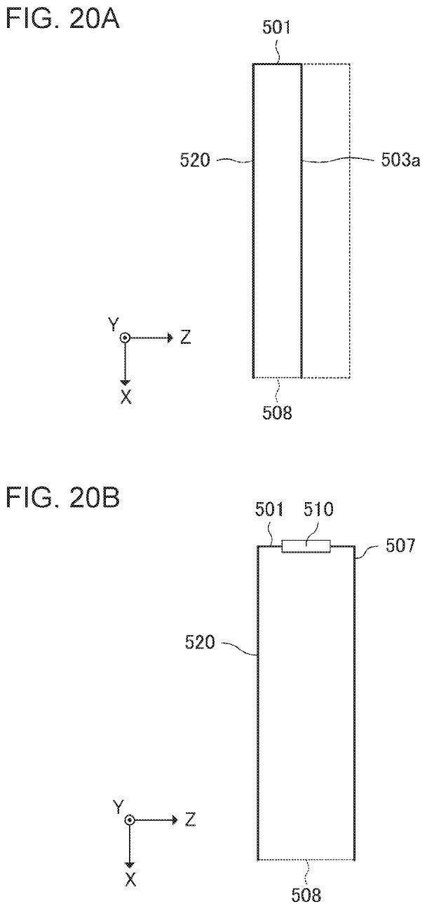

The shape and configuration of a holder 200 according to the present modification in which a battery 20 is held are described. FIG. 19 is a diagram showing an X-Y plane of the holder 200 according to the modification when the holder 200 is seen from the −Z direction. FIG. 20A is a diagram showing a cross-section structure of the holder 200 when the holder 200 is cut along line XXA-XXA shown in FIG. 19. FIG. 20B is a diagram showing a cross-section structure of the holder 200 when the holder 200 is cut along line XXB-XXB shown in FIG. 19. FIG. 21 is a diagram showing a Y-Z plane of the holder 200 when the holder 200 is seen from the +X direction. The holder 200 has the same shape regardless of whether it is seen from the +Y direction or it is seen from the −Y direction. Therefore, a diagram showing the holder 200 when the holder 200 is seen from the −Y direction is omitted.

As shown in FIGS. 19 to 21, the holder 200 has walls 501, 502a, 502b, 503a, 503b, 504a, 504b, 507, and 520, which are plate-like members. Further, although not illustrated in FIGS. 19 to 21, a sealing member with which the holder 200 is sealed after the battery 20a or the battery 20b has been put into the holder 200 may be provided at the after-mentioned opening surface 508 located in the +X direction relative to the holder 200.

The wall 507 extends in the X-Y plane and is located in the +Z direction relative to the holder 200.

At an end of the wall 507 in the +Y direction, the wall 504a, which extends in the −Z direction relative to the wall 507 in an X-Z plane, is located. Further, at an end of the wall 507 in the −Y direction, the wall 504b, which extends in the −Z direction relative to the wall 507 in the X-Z plane, is located. That is, the wall 504a and the wall 504b are located opposite to each other along the Y-axis directions.

At an end of the wall 504a in the −Z direction, the wall 503a, which extends in the +Y direction relative to the wall 504a in the X-Y plane, is located. Further, at an end of the wall 504b in the −Z direction, the wall 503b, which extends in the −Y direction relative to the wall 504b in the X-Y plane, is located. Note here that the wall 503a and the wall 503b are located in the same X-Y plane along the Z-axis directions.

At an end of the wall 503a in the +Y direction, the wall 502a, which extends in the −Z direction relative to the wall 503a in the X-Z plane, is located. Further, at an end of the wall 503b in the −Y direction, the wall 502b, which extends in the −Z direction relative to the wall 503b in the X-Z plane, is located. That is, the wall 502a and the wall 502b are located opposite to each other along the Y-axis directions.

Note here that it is preferable that 0.5×P′<Q′<P′, wherein P′ is the length of each of the walls 502a and 502b along the Z-axis directions and Q is the length of the battery 20a along the Z-axis directions. As will be mentioned later, the walls 502a and 502b correspond to side walls when the battery 20a has been put into the mobile printer 1. Therefore, when P′<Q′, the battery 20a cannot be put into the holder 200. Further, when 0.5×P′>Q′, there is a great gap between an end of the battery 20a in the −Z direction and the after-mentioned wall 520, even if the battery 20a has been put into the holder 200. This may cause a displacement of the battery 20a in the holder 200.

Further, at an end of the wall 507 in the −X direction, the wall 501, which extends in the −Z direction relative to the wall 507 in the Y-Z plane, is located. To this wall 501, an end of each of the aforementioned walls 502a, 502b, 503a, 503b, 504a, 504b, and 507 in the −X direction is coupled.

Note here that it is preferable that 0.5×R′<S′<R′, wherein R′ is the length of the wall 501 along the Z-axis directions and S′ is the length of the battery 20b along the Z-axis directions. As will be mentioned later, the wall 501 corresponds to a side wall when the battery 20b has been put into the mobile printer 1. Therefore, when R′ <S′, the battery 20b cannot be put into the holder 200. Further, when 0.5×R′>S′, there is a great gap between an end of the battery 20b in the −Z direction and the after-mentioned wall 520, even if the battery 20b has been put into the holder 200. This may cause a displacement of the battery 20b in the holder 200.

Further, the wall 520, which extends in the +X direction, is connected to an end of each of the aforementioned walls 501, 502a, and 502b in the −Z direction. That is, the wall 520 is located opposite to the walls 503a, 503b, and 507 along the Z-axis directions.

Further, the holder 200 has an opening surface 508 located at a position in the holder 200 opposite to the wall 501 in the +X direction. Moreover, the battery 20 is held in the holder 200 by being inserted from the +X direction through the opening surface 508.

Having such a shape, the holder 200 can hold batteries 20 of different shapes in one space constituted by the walls 501, 502a, 502b, 503a, 503b, 504a, 504b, 507, and 520, which are plate-like members, and the opening surface 508.

The holder 200 includes a coupler 510 configured to be electrically coupled to the battery 20 held in the holder 200. The coupler 510 is provided in the wall 501, which is an end of the holder 200 in the −X direction.

Further, the mobile printer 1 includes the after-mentioned sealing member 530 as a separate entity from the holder 200. The sealing member 530 is provided so as to be fixable to the holder 200 by a sealing member fixture (not illustrated). The sealing member 530 includes fixtures 511a, 511b, and 512 configured to fix the battery 20 put into the holder 200. Moreover, in the holder 200, a battery 20 of a first shape is fixedly held by the coupler 510 and the fixtures 511a and 511b of the sealing member 530, or a battery 20 of a second shape differing from the first shape is fixedly held by the coupler 510 and the fixture 512 of the sealing member 530. Note here that the fixtures 511a, 511b, and 512 are configured to include, for example, elastic members such as springs. Moreover, once a battery 20 is held in the holder 200, the battery 20 is fixed between stress caused by the elastic member(s) and the coupler 510.

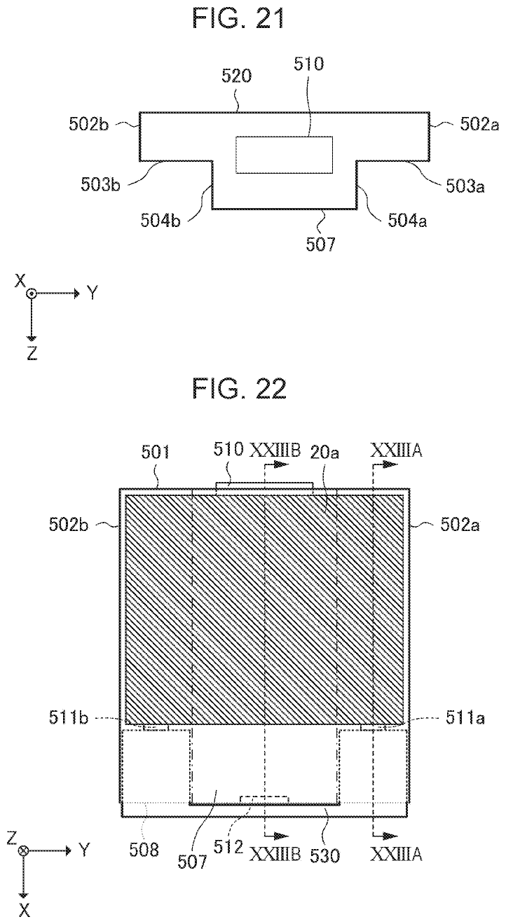

Examples of cases where a battery 20 is held in the holder 200 are described with reference to FIGS. 22 to 27.

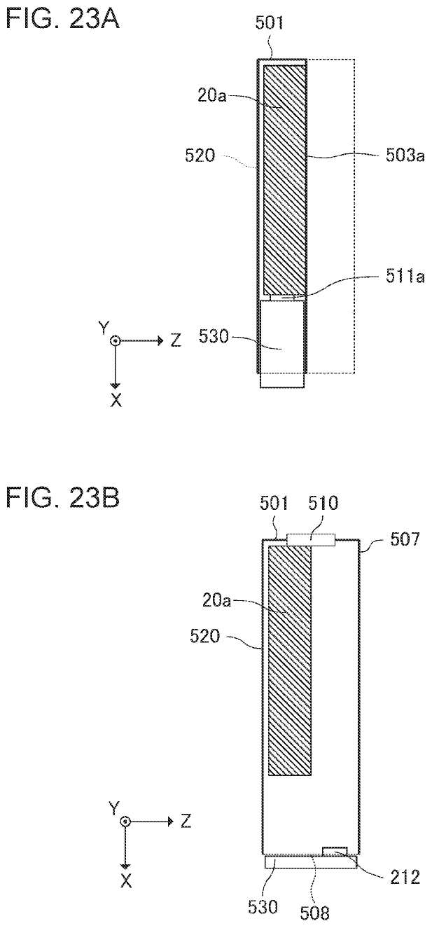

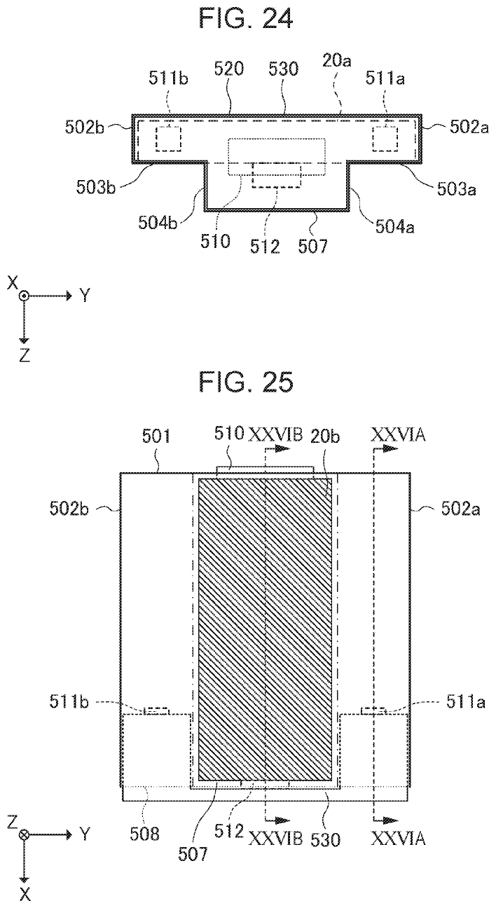

FIG. 22 is a diagram showing the X-Y plane of the holder 200 according to the modification when the holder 200 is seen from the −Z direction in a case in which a battery 20 of a first shape is fixedly held in the holder 200. FIG. 23A is a diagram showing a cross-section structure of the holder 200 of the modification when the holder 200 is cut along line XXIIIA-XXIIIA while holding the battery 20 of the first shape shown in FIG. 22. FIG. 23B is a diagram showing a cross-section structure of the holder 200 of the modification when the holder 200 is cut along line XXIIIB-XXIIIB while holding the battery 20 of the first shape shown in FIG. 22. FIG. 24 is a diagram showing the Y-Z plane of the holder 200 according to the modification when the holder 200 is seen from the +X direction in a case in which the battery 20 of the first shape is fixedly held in the holder 200.

As shown in FIGS. 22 to 24, the battery 20a put into the holder 200 is held in the holder 200 by being retained by the walls 503a and 503b and fixed by the coupler 510 and the fixtures 511a and 511b of the sealing member 530 in a substantially cuboidal holding region configured to include the walls 501, 502a, 502b, 503a, 503b, and 520. In other words, the battery 20a is fixedly held in the substantially cuboidal holding region configured to include the walls 501, 502a, 502b, 503a, 503b, and 520. In this case, the battery 20a is electrically coupled to the coupler 510. Note here that the substantially cuboidal holding region configured to include the walls 501, 502a, 502b, 503a, 503b, and 520 is an example of a first holder according to the modification and the battery 20a held in the substantially cuboidal holding region configured to include the walls 501, 502a, 502b, 503a, 503b, and 520 is an example of a first all-solid battery according to the modification.

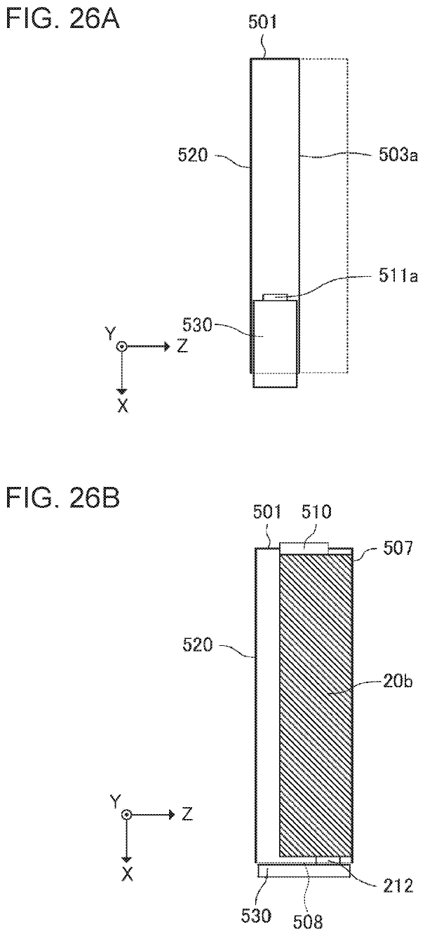

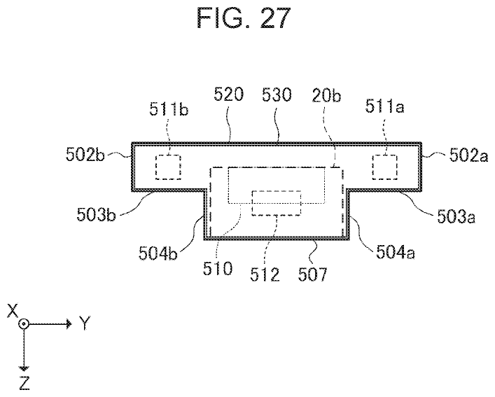

FIG. 25 is a diagram showing the X-Y plane of the holder 200 according to the modification when the holder 200 is seen from the −Z direction in a case in which a battery 20 of a second shape differing in shape from the battery 20a is fixedly held in the holder 200. FIG. 26A is a diagram showing a cross-section structure of the holder 200 of the modification when the holder 200 is cut along line XXVIA-XXVIA while holding the battery 20 of the second shape shown in FIG. 25. FIG. 26B is a diagram showing a cross-section structure of the holder 200 of the modification when the holder 200 is cut along line XXVIB-XXVIB while holding the battery 20 of the second shape shown in FIG. 25. FIG. 27 is a diagram showing the Y-Z plane of the holder 200 according to the modification when the holder 200 is seen from the +X direction in a case in which the battery 20 of the second shape is fixedly held in the holder 200.

As shown in FIGS. 25 to 27, the battery 20b put into the holder 200 is held in the holder 200 by being retained by the wall 507 and fixed by the coupler 510 and the fixture 512 of the sealing member 530 in a substantially cuboidal holding region configured to include the walls 501, 504a, 504b, 507, and 520. In other words, the battery 20b is fixedly held in the substantially cuboidal holding region configured to include the walls 501, 504a, 504b, 507, and 520. In this case, the battery 20b is electrically coupled to the coupler 510. Note here that the substantially cuboidal holding region configured to include the walls 501, 504a, 504b, 507, and 520 is an example of a second holder according to the modification and the battery 20b held in the substantially cuboidal holding region configured to include the walls 501, 504a, 504b, 507, and 520 is an example of a second all-solid battery according to the modification.

Although the present modification has been described assuming that the wall 520 located at an end of the first holder in the −Z direction is located at the same position as an end of the second holder in the −Z direction and the wall 507 located at an end of the first holder in the +Z direction is located further in the +Z direction than the walls 503a and 503b located at an end of the second holder in the +Z direction, this is not intended to impose any limitation, and for example, the end of the first holder in the −Z direction may be located further in the +Z direction than the end of the second holder in the −Z direction and the end of the first holder in the +Z direction may be located at the same position as the end of the second holder in the +Z direction.

### 1.7 Another Modification

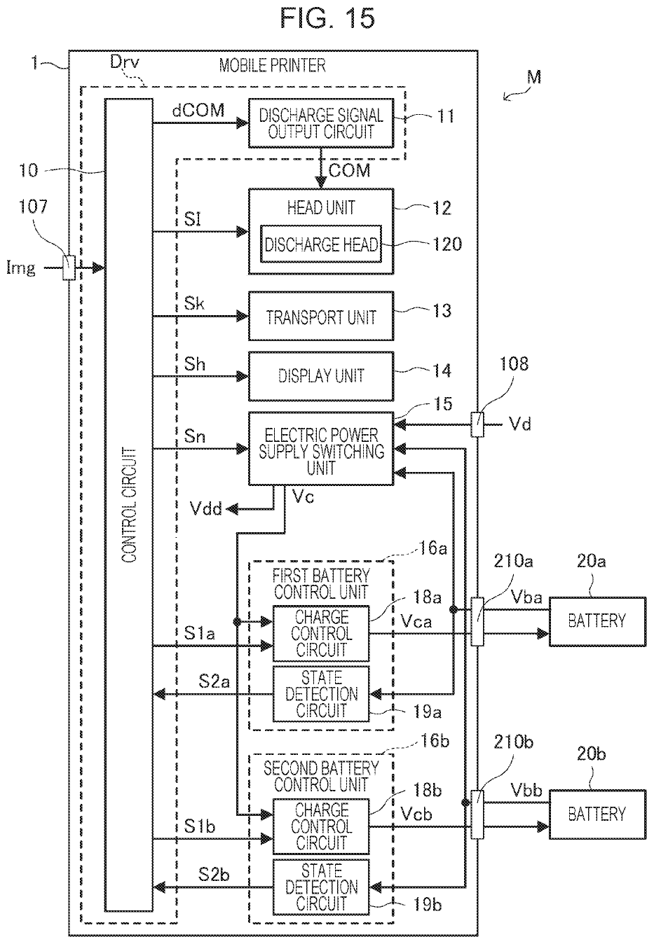

The mobile printer 1 serving as the mobile device M described above may include two couplers 210 corresponding to batteries 20a and 20b, respectively, that are held in the holder 200. That is, as shown in FIG. 15, the mobile printer 1 may include a coupler 210a configured to be electrically coupled to the battery 20a when the battery 20a is held in the holder 200 and a coupler 210b configured to be electrically coupled to the battery 20b when the battery 20b is held in the holder 200. This makes it possible to provide the coupler 210a in a shape suitable for batteries 20a of different shapes and the coupler 210b in a shape suitable for a battery 20b and makes it possible to improve the reliability of electrical coupling of the batteries 20a and 20b. Note here that the couplers 210a and 210b are examples of first and second couplers, respectively, according to another modification.

Further, when the holder 200 includes the couplers 210a and 210b in correspondence with batteries 20a and 20b of different shapes, respectively, a holding region in which a battery 20a is fixedly held and a holding region in which a battery 20b serving as the battery 20 and differing in shape from the battery 20a is fixedly held may be located in the holder 200 so as not to overlap each other. This makes is possible to fixedly hold the batteries 20a and 20b of different shapes in the holder 200 at the same time and allows the mobile printer 1 to store a larger amount of charge in the battery 20. This makes it possible to lengthen the duration of driving of the mobile printer 1 when the mobile printer 1 is driven by the battery 20.

Further, it is possible to detect whether a battery 20a is held in the holder 200 and whether a battery 20b is held in the holder 200 and control an operating state of the mobile printer 1 on the basis of a detection result. Note here that an operating state of the mobile printer 1 in a case where a battery 20a is held in the holder 200 is an example of a first drive state, and an operating state of the mobile printer 1 in a case where a battery 20b is held in the holder 200 is an example of a second drive state.

FIG. 15 is a diagram showing a functional configuration of a mobile device M according to a modification. As shown in FIG. 15, the mobile printer 1 includes a coupler 210a to which a battery 20a is electrically coupled and a coupler 210b to which a battery 20b is electrically coupled. Further, the mobile printer 1 includes a first battery control unit 16a serving as a battery control unit 16 corresponding to the battery 20a coupled to the coupler 210a and a second battery control unit 16a serving as a battery control unit 16 corresponding to the battery 20b coupled to the coupler 210b.

The first battery control unit 16a includes a charge control circuit 18a that controls charging of the battery 20a and a state detection circuit 19a that detects a state of the battery 20a and that generates and outputs a state signal S2a representing the state. The state detection circuit 19a detects, as a state of the battery 20a, a voltage value of a voltage Vba supplied from the battery 20a, thereby detecting that the battery 20a is in a state of being coupled to the coupler 210a. In other words, the state detection circuit 19a detects whether the battery 20a is held in the holder 200. Moreover, the state detection circuit 19a generates, on the basis of the voltage value of the voltage Vba, a state signal S2a representing the state of the battery 20a, and outputs the state signal S2a to the control circuit 10. Upon receiving the state signal S2a, the control circuit 10 generates, in accordance with the state signal S2a, a control signal Sla indicating whether to charge the battery 20a and outputs the control signal Sla to the charge control circuit 18a. In accordance with the control signal Sla, the charge control circuit 18a switches whether to output the voltage Vc, which is inputted from the electric power supply switching unit 15, as a voltage Vca with which to charge the battery 20a.

The second battery control unit 16b includes a charge control circuit 18b that controls charging of the battery 20b and a state detection circuit 19b that detects a state of the battery 20b and that generates and outputs a state signal S2b representing the state. The state detection circuit 19b detects, as a state of the battery 20b, a voltage value of a voltage Vbb supplied from the battery 20b, thereby detecting that the battery 20b is in a state of being coupled to the coupler 210b. In other words, the state detection circuit 19b detects whether the battery 20b is held in the holder 200. Moreover, the state detection circuit 19b generates, on the basis of the voltage value of the voltage Vbb, a state signal S2b representing the state of the battery 20b, and outputs the state signal S2b to the control circuit 10. Upon receiving the state signal S2b, the control circuit 10 generates, in accordance with the state signal S2b, a control signal Sib indicating whether to charge the battery 20b and outputs the control signal S1b to the charge control circuit 18b. In accordance with the control signal Sib, the charge control circuit 18b switches whether to output the voltage Vc, which is inputted from the electric power supply switching unit 15, as a voltage Vcb with which to charge the battery 20b.

The control circuit 10 controls driving of the head unit 12, the transport unit 13, and the display unit 14 in accordance with the state signal S2a outputted from the state detection circuit 19a and the state signal S2b outputted from the state detection circuit 19b. In other words, the control circuit 10 controls the head unit 12, the transport unit 13, and the display unit 14 on the basis of detection results yielded by the state detection circuit 19a and the state detection circuit 19b. That is, the mobile printer 1 according to the modification can operate in accordance with the characteristics of batteries 20 mounted therein.

Note here that the head unit 12, the transport unit 13, and the display unit 14, which are driven on the basis of electric power corresponding to the voltages Vba and Vbb supplied from the batteries 20a and 20b are examples of drive circuits, that the state detection circuit 19a is an example of a first detection circuit, and that the state detection circuit 19b is an example of a second detection circuit. Moreover, the control circuit 10, which controls driving of the head unit 12, the transport unit 13, and the display unit 14, is an example of a control circuit.

Further, the holder 200 may include a holding region in which a battery 20c differing in shape from the battery 20a and differing in shape from the battery 20b is fixedly held. The inclusion by the holder 200 of the holding region in which the battery 20c further differing from the batteries 20a and 20b is fixedly held makes it possible to further enhance the versatility of a mobile device M in which a battery 20, which is an all-solid battery, is mounted. Note here that the battery 20c is an example of a third all-solid battery and the holding region of the holder 200 in which the battery 20c is held is an example of a third holder.

### 2. SECOND EMBODIMENT

A mobile device of a second embodiment is described by taking as an example a smartphone that displays various information on a display panel and that is configured to operate on a battery. In a description of the mobile device of the second embodiment, the same components are given the same signs, and a description of such components is omitted or simplified.

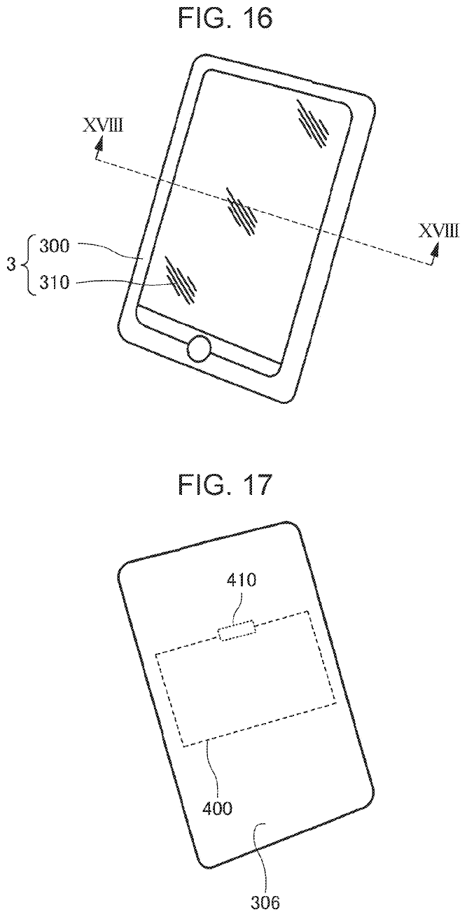

FIGS. 16 to 18 are diagrams for explaining a configuration of a smartphone 3 serving as the mobile device M. It should be noted that the following description uses an X axis, a Y axis, and a Z axis that are orthogonal to one another. Further, a direction toward a starting point of the X axis and a direction toward a side opposite to the starting point may be referred to as “−X direction” and “+X direction”, respectively, and the “−X direction” and the “+X direction” are collectively referred to as “X-axis directions”. Similarly, a direction toward a starting point of the Y axis and a direction toward a side opposite to the starting point may be referred to as “−Y direction” and “+Y direction”, respectively, and the “−Y direction” and the “+Y direction” are collectively referred to as “Y-axis directions”. Similarly, a direction toward a starting point of the Z axis and a direction toward a side opposite to the starting point may be referred to as “−Z direction” and “+Z direction”, respectively, and the “−Z direction” and the “+Z direction” are collectively referred to as “Z-axis directions”. Further, although the following description assumes that the X axis, the Y axis, and the Z axis are orthogonal to one another, units of the smartphone 3 serving as the mobile device M are not necessarily orthogonal to one another.

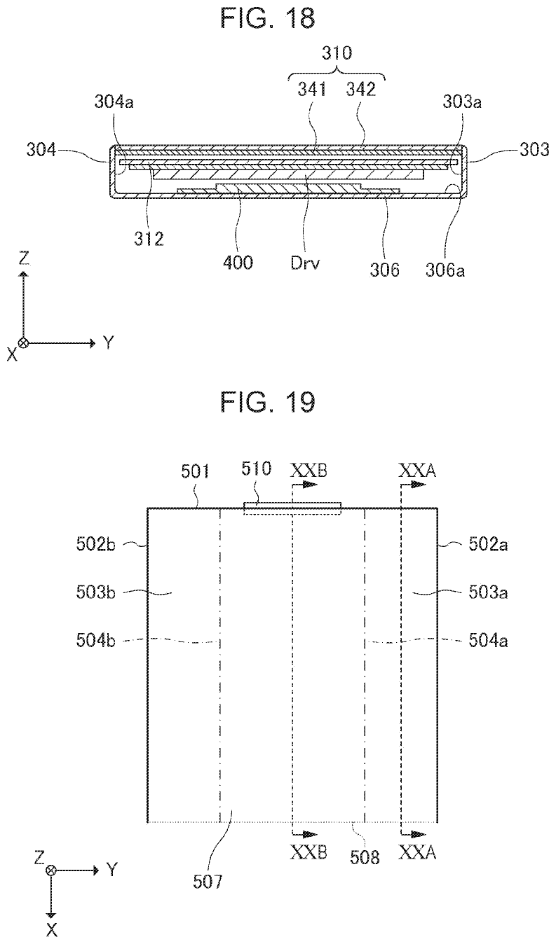

FIG. 16 is a diagram of the mobile device M of the second embodiment as seen from the front. FIG. 17 is a diagram of the mobile device M of the second embodiment as seen from the rear. FIG. 18 is a diagram showing a cross-section structure of the mobile device M of the second embodiment when the mobile device M is cut along line XVIII-XVIII in FIG. 16.

As shown in FIG. 16, the smartphone 3 serving as the mobile device M includes a housing 300 and a display panel 310. Further, as shown in FIG. 17, the smartphone 3 includes a holder 400 in which a battery 20 is held and a coupler 410 configured to be electrically coupled to the battery 20 held in the holder 400.

As shown in FIGS. 16 to 18, the housing 300 is shaped to have walls 303, 304, and 306 and one open surface. The wall 306 is located opposite to an opening surface serving as the open surface of the housing 100. The wall 303 is located in the +Y direction relative to the housing 300. The wall 304 is located in the −Y direction relative to the housing 300. Furthermore, although not illustrated in FIGS. 16 to 18, the housing 300 has walls located opposite to each other along the X-axis directions. That is, the housing 300 has a substantially cuboidal shape with one open surface.

Further, the display panel 310 is provided at the opening surface of the housing 300 opposite to the wall 306 in a direction parallel to the Z-axis directions. The display panel 310 includes a display section 341 and a sensor section 342 stacked on the display section 341. The display section 341 is formed to include a liquid crystal panel, an electric paper panel, an organic electroluminescence panel, or other panels. Further, the sensor section 342 functions as an operation section that accepts an operation carried out by a user. Applicable examples of the sensor section 342 include a resistive sensor, a capacitive sensor, and a surface acoustic wave sensor. That is, in the present embodiment, the display panel 310 is a so-called touch panel into which the display section 341 and the sensor section 342, which is equivalent to an operation switch, are integrated. This display panel 310 is equivalent to the display unit 14 according to the first embodiment.

The housing 300 of the smartphone 3 thus configured is provided with the display panel 310, a drive unit Dry, and the holder 400, in which a battery 20, which is an example of an all-solid battery, is held.

Specifically, as shown in FIG. 18, the holder 400, in which a battery 20 is fixedly held, is provided in contact with an inner surface 306a of the wall 306 of the housing 300. The wall 306, which is in contact with the holder 400, may be provided with an openable and closable lid (not illustrated). Further, in the +Z direction relative to the holder 400, a circuit board 312 mounted with the drive unit Dry is located, and in the +Z direction relative to the circuit board 312, the display panel 310 is located.

Even in the smartphone 3 serving as the mobile device M according to the second embodiment thus configured, the holder 400, as is the case with the holder 200 shown in FIGS. 6 to 8 of the first embodiment, includes a holding region in which a battery 20a serving as the battery 20 is fixedly held and a holding region in which a battery 20b serving as the battery 20 and differing in shape from the battery 20a is fixedly held, and integrally configuring, in the holder 400, the holding region in which the battery 20a is fixedly held and the holding region in which the battery 20b differing in shape from the battery 20a is fixedly held makes it possible to bring about the same working effects as the mobile printer 1 serving as the mobile device M according to the first embodiment.

### 3. OTHER EMBODIMENTS

The mobile device M of the first embodiment has been described above by taking the portable mobile printer 1 as an example, and the mobile device M of the second embodiment has been described above by taking the smartphone 3 as an example; however, a mobile device M needs only be a battery-driven portable device, and applicable examples of mobile devices M include various types of mobile devices M such as a tablet terminal, a mobile phone, an electronic computer, and a digital audio player. Even in such cases, it is possible to bring about the same working effects as the first embodiment and the second embodiment.

Although the foregoing has described embodiments and modifications, the present disclosure is not limited to these embodiments and may be carried out in various aspects without departing from the scope of the present disclosure. For example, the embodiments described above may be combined as appropriate.

The present disclosure encompasses a configuration substantially identical (e.g. a configuration identical in function, method, and result or a configuration identical in object and effect) to a configuration described in an embodiment. Further, the present disclosure encompasses a configuration obtained by substituting a non-essential part of a configuration described in an embodiment. Further, the present disclosure encompasses a configuration that brings about the same working effects as a configuration described in an embodiment or a configuration that can attain the same object as a configuration described in an embodiment. Further, the present disclosure encompasses a configuration obtained by adding a known technology to a configuration described in an embodiment.

What is claimed is:

1. A mobile device configured to be driven based on electric power, the mobile device comprising:
a holder in which an all-solid battery having a solid electrolyte is held; and
a coupler configured to be electrically coupled to the all-solid battery held in the holder,
wherein the holder includes
a first holder in which a first all-solid battery is fixedly held as the all-solid battery, and
a second holder in which a second all-solid battery differing in shape from the first all-solid battery is fixedly held as the all-solid battery.

2. The mobile device according to claim 1, wherein
the coupler is electrically coupled to the first all-solid battery when the first all-solid battery is held in the first holder, and
the coupler is electrically coupled to the second all-solid battery when the second all-solid battery is held in the second holder.

3. The mobile device according to claim 1, wherein
the coupler includes a first coupler and a second coupler,
the first coupler is electrically coupled to the first all-solid battery when the first all-solid battery is held in the first holder, and
the second coupler is electrically coupled to the second all-solid battery when the second all-solid battery is held in the second holder.

4. The mobile device according to claim 1, further comprising:
a drive circuit configured to be driven based on electric power supplied from the all-solid battery; and
a control circuit that, when the first all-solid battery is held in the first holder, operates the drive circuit in a first drive state and that, when the second all-solid battery is held in the second holder, operates the drive circuit in a second drive state differing from the first drive state.

5. The mobile device according to claim 1, wherein the first holder and the second holder partially overlap each other in the holder.

6. The mobile device according to claim 1, wherein the first holder and the second holder do not overlap each other in the holder.

7. The mobile device according to claim 1, further comprising a notifier that notifies information on the all-solid battery held in the holder.

8. The mobile device according to claim 1, wherein
the first holder and the second holder are located adjacent to each other along a first direction in the holder, and
the coupler is located at an end of the holder in a second direction crossing the first direction.

9. The mobile device according to claim 8, wherein a length of the first holder in the second direction is smaller than a length of the second holder in the second direction.

10. The mobile device according to claim 8, wherein a length of the first holder in a third direction crossing the first direction and the second direction is larger than a length of the second holder in the third direction.

11. The mobile device according to claim 1, further comprising a third holder in which a third all-solid battery differing in shape from the first all-solid battery and differing in shape from the second all-solid battery is held.

12. The mobile device according to claim 1, wherein a rated capacity of the first all-solid battery and a rated capacity of the second all-solid battery are substantially equal to each other.

13. The mobile device according to claim 1, wherein the first holder and the second holder are integrally configured in the holder.
